(19) United States
(12) Patent Application Publication
(10) Pub. No.: US 2024/0188498 A1
(43) Pub. Date: Jun. 13, 2024

(54) HARVESTER REEL HAVING SELF-ADJUSTING TINE BARS

(71) Applicant: CNH Industrial America LLC, New Holland, PA (US)

(72) Inventors: Cory Douglas Hunt, II, Millersville, PA (US); Joel T. Cook, Akron, PA (US); Bart M.A. Missotten, Herent (BE); Bart Lenaerts, Heverlee (BE); Herbert M. Farley, Elizabethtown, PA (US); Nathaniel Smith, Lancaster, PA (US); Yvan C.C. Vandergucht, Lo-Reninge (BE); John L. Hinkle, York Springs, PA (US)

(21) Appl. No.: 18/287,995

(22) PCT Filed: Apr. 21, 2022
(86) PCT No.: PCT/US22/25849

§ 371 Date: Oct. 23, 2023

Related U.S. Application Data
(60) Provisional application No. 63/201,270, filed on Apr. 21, 2021.

(51) Int. Cl. A01D 57/03; A01D 34/00

(52) U.S. Cl. CPC A01D 57/03; A01D 34/006

(57) ABSTRACT

A harvester reel for an agricultural harvester. The harvester reel includes a central rotatable shaft, and a plurality of reel tine bars extending widthwise across the reel and connected to the central rotatable shaft for rotation therewith. Each of the plurality of reel tine bars includes a biasing member for biasing the reel tine bar to rotate about its central longitudinal axis, and a plurality of tines. A cam assembly guides rotation of the plurality of reel tine bars. The cam assembly includes a primary cam for guiding rotation of the tine bars during rotation of the central rotatable shaft, and a moveable or stationary secondary cam. The moveable secondary cam pivots the tine bars about their longitudinal axes away from a cutterbar. Alternatively, a moveable diverter cooperates with the stationary secondary cam to pivot the reel tine bars about their longitudinal axes away from the cutterbar.

### FIELD OF THE INVENTION

The present disclosure relates generally to a harvester reel for an agricultural harvester header having self-adjusting tine bars.

### BACKGROUND OF THE INVENTION

Harvester reels are used on agricultural harvesters to guide crops to a cutting apparatus, e.g., a cutterbar. Reel-cutterbar interference is a well-known problem in harvester headers equipped with a flexible cutterbar or a cutterbar that can move vertically with respect to the reel. If the cutterbar flexes upwardly far enough it can cut plastic reel tines or experience damage if it comes into contact with metal reel tines. Shortened plastic tines can be very costly to replace in wider headers due to the sheer number of tines that must be replaced, and cutterbar damage caused by metal tines can result in significant harvester downtime.

### SUMMARY OF THE INVENTION

In accordance with an exemplary embodiment, the present disclosure provides a harvester reel for an agricultural harvester header. The harvester reel includes a central rotatable shaft, and a plurality of reel tine bars extending widthwise across the reel and connected to the central rotatable shaft for rotation therewith. Each of the plurality of reel tine bars includes a biasing member for biasing the reel tine bar to rotate about a central longitudinal axis, and a tine. The harvester reel further includes a cam assembly for guiding rotation of the plurality of reel tine bars.

According to an aspect, the cam assembly includes a primary cam for guiding rotation of the tine bars during rotation of the central rotatable shaft, and a secondary cam moveable between a disengaged position and an engaged position.

According to another aspect, the cam assembly includes a primary cam for guiding rotation of the tine bars during rotation of the central rotatable shaft, a secondary cam, and a diverter adjacent the secondary cam, wherein the diverter is moveable between a disengaged position and an engaged position.

In accordance with another exemplary embodiment, the present disclosure provides an agricultural harvester header comprising the above-described harvester reel and a cutterbar carried below the harvester reel.

In accordance with another exemplary embodiment, the present disclosure provides an agricultural harvester comprising the above-described agricultural harvester header.

In accordance with another exemplary embodiment, the present disclosure provides a harvester reel for an agricultural harvester header. The harvester reel includes a central rotatable shaft, and a plurality of reel tine bars extending widthwise across the reel and connected to the central rotatable shaft for rotation therewith. Each of the plurality of reel tine bars includes a biasing member for biasing the reel tine bar to rotate about its central longitudinal axis, a follower operatively connected to the reel tine bar, and a tine. The harvester reel further includes a cam assembly including a primary cam for guiding rotation of the tine bars during rotation of the central rotatable shaft, and a secondary cam. The cam assembly further includes a diverter adjacent the secondary cam, wherein the diverter is movable between a disengaged position and an engaged position, wherein in the engaged position, the follower of at least one of the plurality of reel tine bars cams against the secondary cam, and an actuator for moving the diverter between the disengaged and engaged positions.

In accordance with another exemplary embodiment, the present disclosure provides a harvester reel for an agricultural harvester header. The harvester reel includes a central rotatable shaft, and a plurality of reel tine bars extending widthwise across the reel and connected to the central rotatable shaft for rotation therewith. The harvester reel further includes a cam assembly for guiding rotation of the plurality of reel tine bars. The cam assembly includes a primary cam for guiding rotation of the tine bars during rotation of the central rotatable shaft, and a secondary cam moveable between a disengaged position and an engaged position.

In accordance with another exemplary embodiment, the present disclosure provides a harvester reel for an agricultural harvester header. The harvester reel includes a central rotatable shaft, and a plurality of reel tine bars extending widthwise across the reel and connected to the central rotatable shaft for rotation therewith. The harvester reel further includes a cam assembly for guiding rotation of the plurality of reel tine bars. The cam assembly includes a primary cam for guiding rotation of the tine bars during rotation of the central rotatable shaft, a secondary cam, and a diverter adjacent the secondary cam, wherein the diverter is moveable between a disengaged position and an engaged position.

In accordance with another exemplary embodiment, the present disclosure provides a harvester reel for an agricultural harvester header. The harvester reel includes a central rotatable shaft, and a plurality of rotatable reel tine bars extending widthwise across the reel and connected to the central rotatable shaft for rotation therewith. The harvester reel further includes a primary tine bar guiding mechanism configured to guide rotation of the tine bars during rotation of the central rotatable shaft, and a secondary tine bar mechanism configured to guide rotation of the tine bars during a portion of a complete revolution of rotation of the central rotatable shaft.

### BRIEF DESCRIPTION OF THE DRAWINGS

The foregoing summary, as well as the following detailed description of the exemplary embodiments of the subject disclosure, will be better understood when read in conjunction with the appended drawings. For the purpose of illustrating the subject disclosure, there are shown in the drawings exemplary embodiments. It should be understood, however, that the subject disclosure is not limited to the precise arrangements and instrumentalities shown. In the drawings:

FIG. 1 is a side elevation view of an agricultural harvester in accordance with an exemplary embodiment of the subject disclosure;

FIG. 2 is a front elevation view of the agricultural harvester of FIG. 1;

FIG. 3 is an external end view of a primary cam of a reel cam assembly of a harvester reel in accordance with an exemplary embodiment of the subject disclosure;

FIG. 4 is an external end view of a secondary cam of a reel cam assembly of a harvester reel in accordance with an exemplary embodiment of the subject disclosure in a disengaged position;

FIG. 5 is an external end view of a secondary cam of a reel cam assembly of a harvester reel in accordance with an exemplary embodiment of the subject disclosure in an engaged position;

FIG. 6 is a perspective view of an end of a harvester reel in accordance with an exemplary embodiment of the subject disclosure;

FIG. 7 is an enlarged perspective view of the end of the harvester reel shown in FIG. 6;

FIG. 8 is an external lateral end view of a diverter of a reel cam assembly of a harvester reel in accordance with another exemplary embodiment of the subject disclosure in a disengaged position;

FIG. 9 is an enlarged lateral external end view of the reel cam assembly of FIG. 8;

FIG. 10 is a partial perspective internal end view of the reel cam assembly of FIG. 9;

FIG. 11 is an external lateral end view of a diverter of a reel cam assembly of a harvester reel in accordance with another exemplary embodiment of the subject disclosure in an engaged position;

FIG. 12 is a partial enlarged external end view of the reel cam assembly of FIG. 11;

FIG. 13 is a perspective internal end view of the reel cam assembly of FIG. 12;

FIGS. 14A-14D are sequential schematic views of the operation of a tine bar in accordance with an exemplary embodiment of the subject disclosure as a cutterbar approaches and moves away from a harvester reel carrying the tine bar; and

FIGS. 15A-15D are sequential schematic views of the operation of a tine bar in accordance with another exemplary embodiment of the subject disclosure as a cutterbar approaches and moves away from a harvester reel carrying the tine bar.

### DETAILED DESCRIPTION OF THE DRAWINGS

Reference will now be made in detail to the various exemplary embodiments of the subject disclosure illustrated in the accompanying drawings. Wherever possible, the same or like reference numbers will be used throughout the drawings to refer to the same or like features. It should be noted that the drawings are in simplified form and are not drawn to precise scale. Certain terminology is used in the following description for convenience only and is not limiting. Directional terms such as top, bottom, left, right, above, below and diagonal, are used with respect to the accompanying drawings. The term “distal” shall mean away from the center of a body. The term “proximal” shall mean closer towards the center of a body and/or away from the “distal” end. The words “inwardly” and “outwardly” refer to directions toward and away from, respectively, the geometric center of the identified element and designated parts thereof. Such directional terms used in conjunction with the following description of the drawings should not be construed to limit the scope of the subject application in any manner not explicitly set forth. Additionally, the term “a,” as used in the specification, means “at least one.” The terminology includes the words above specifically mentioned, derivatives thereof, and words of similar import.

The terms “grain,” “ear,” “stalk,” “leaf,” and “crop material” are used throughout the specification for convenience and it should be understood that these terms are not intended to be limiting. Thus, “grain” refers to that part of a crop which is harvested and separated from discardable portions of the crop material. The header of the subject application is applicable to a variety of crops, including but not limited to wheat, soybeans and small grains. The terms “debris,” “material other than grain,” and the like are used interchangeably.

“About” as used herein when referring to a measurable value such as an amount, a temporal duration, and the like, is meant to encompass variations of ±20%, ±10%, ±5%, ±1%, or ±0.1% from the specified value, as such variations are appropriate.

“Substantially” as used herein shall mean considerable in extent, largely but not wholly that which is specified, or an appropriate variation therefrom as is acceptable within the field of art. “Exemplary” as used herein shall mean serving as an example.

Throughout the subject application, various aspects thereof can be presented in a range format. It should be understood that the description in range format is merely for convenience and brevity and should not be construed as an inflexible limitation on the scope of the subject disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

Furthermore, the described features, advantages and characteristics of the exemplary embodiments of the subject disclosure may be combined in any suitable manner in one or more embodiments. One skilled in the relevant art will recognize, in light of the description herein, that the subject disclosure can be practiced without one or more of the specific features or advantages of a particular exemplary embodiment. In other instances, additional features and advantages may be recognized in certain embodiments that may not be present in all exemplary embodiments of the present disclosure.

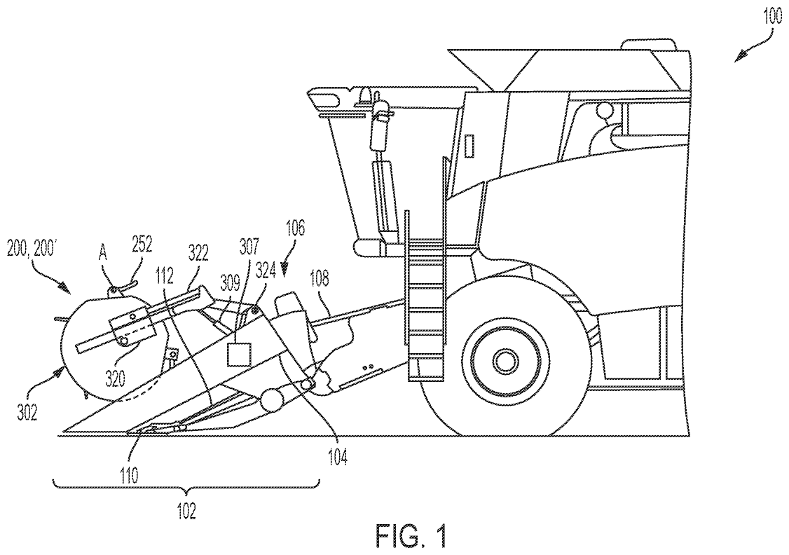

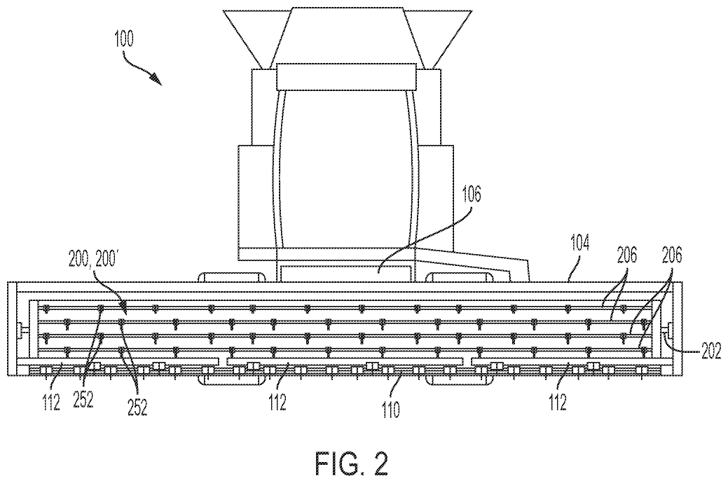

Referring now to the drawings, FIGS. 1 and 2 illustrate an agricultural harvester 100 in accordance with an exemplary embodiment of the subject disclosure. The agricultural harvester e.g., a combine harvester 100, includes a header 102 having a chassis or frame 104 that is attached to a forward end 106 of the harvester. The header 102 is configured to cut crops with a cutterbar 110 as the harvester 100 moves forward over a crop field. It is appreciated that the cutterbar 110 includes one or more reciprocating sickles, such as those disclosed in U.S. Pat. No. 8,151,547, the entire disclosure of which is incorporated herein by reference for all purposes. The header includes a harvester reel 200, 200′ and one or more draper belts, including draper belt 112 for moving crop materials towards a feederhouse 108.

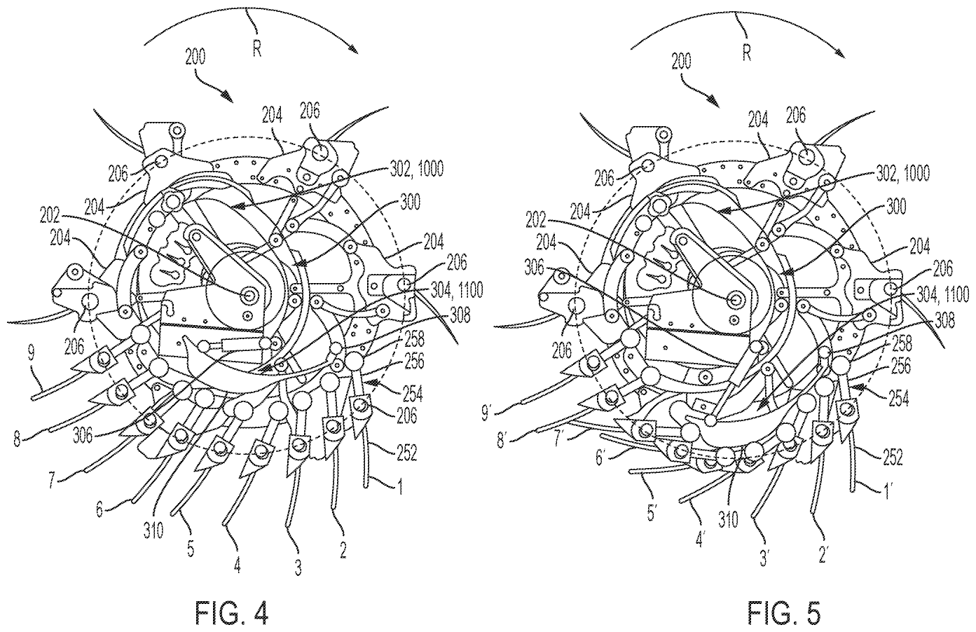

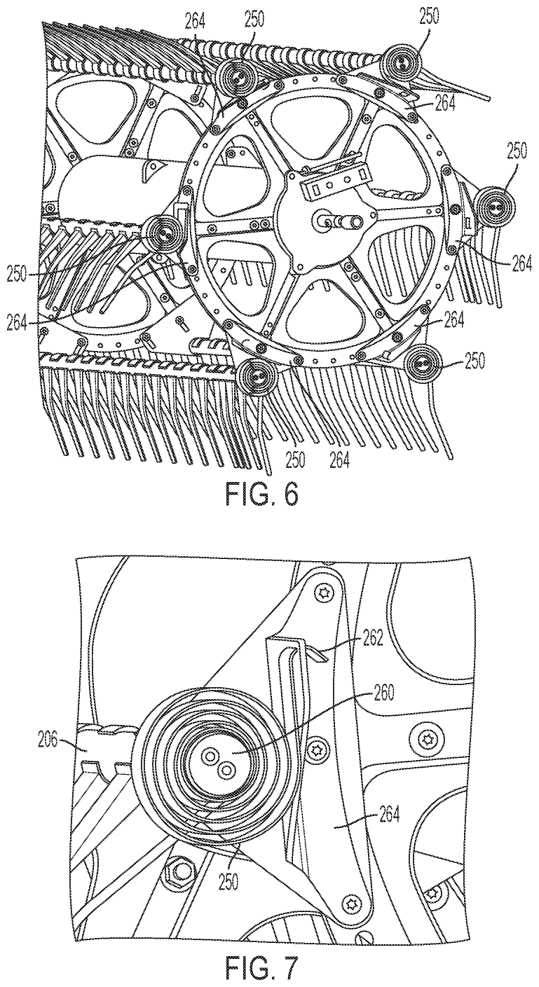

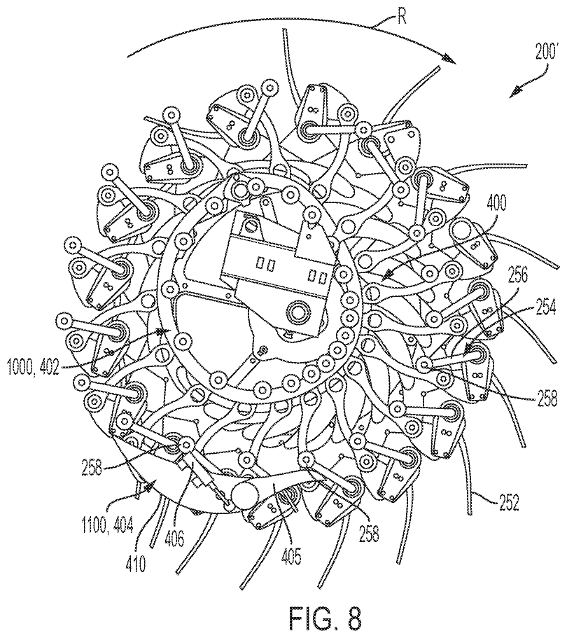

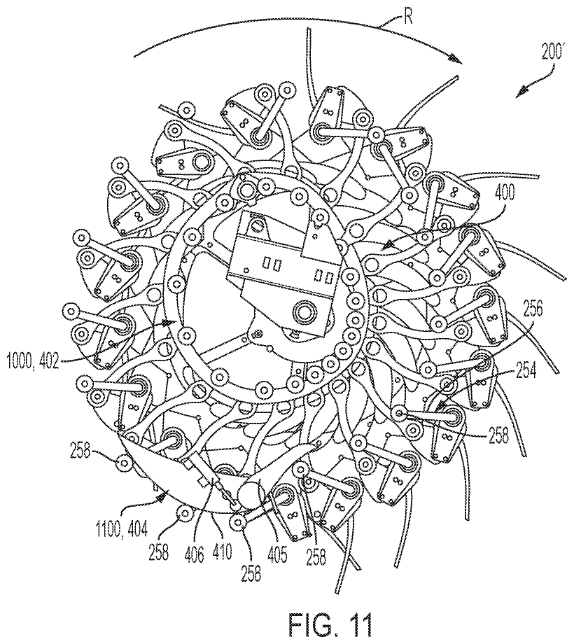

The harvester reel 200, 200′ is mounted on the header 102 and generally spans laterally or widthwise of the header. The harvester reel includes a central rotatable shaft or axle 202. A plurality of reel tine bars 206 extend widthwise across the reel and are connected to the central rotatable shaft for rotation therewith. Each of the plurality of reel tine bars is rotatable and includes a biasing member 250 (FIGS. 6 and 7) for biasing the reel tine bar about its central longitudinal axis “A” (FIG. 1) and at least one tine 252 for gathering and directing crop downwardly and rearwardly into the header 102 for subsequent cutting and harvesting operations. As shown in FIGS. 4, 5, 8 and 11, the harvester reel further includes a primary tine bar guiding mechanism 1000 configured to guide rotation of the tine bars during rotation of the central rotatable shaft, and a secondary tine bar guiding mechanism 1100 configured to guide rotation of the tine bars during a portion of a complete revolution of rotation of the central rotatable shaft. According to exemplary “cam reel” embodiments of the subject disclosure, the primary and secondary tine bar guiding mechanisms are incorporated into a cam assembly 300 (FIGS. 4 and 5) or 400 (FIGS. 8 and 11) at a lateral end of the harvester reel for guiding rotation of the plurality of tine bars.

The central rotatable shaft 202 is an axle powered by the header 102 to drive operations of the harvester reel. The central rotatable shaft supports the harvester reel and rotates about a longitudinal axis of the harvester reel.

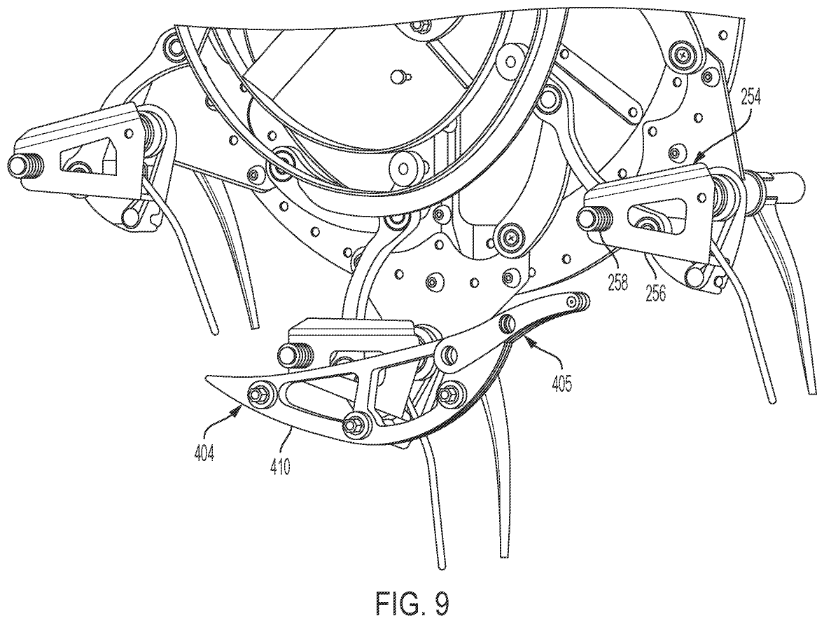

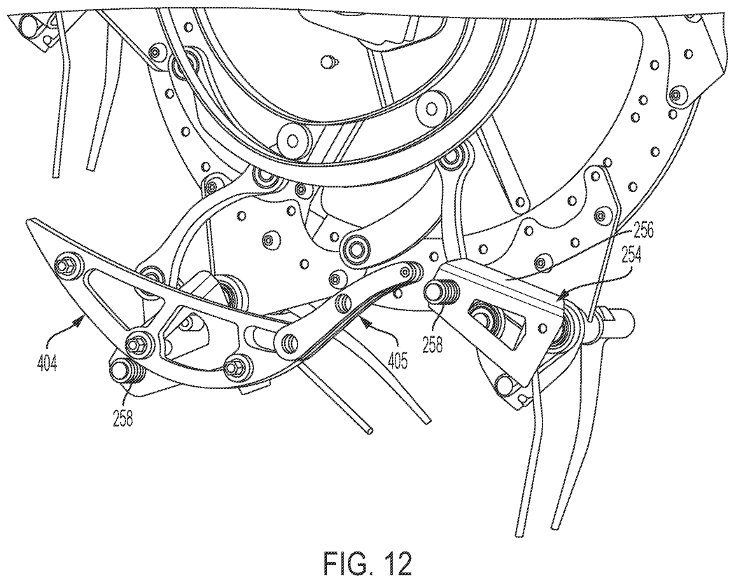

As best shown in FIGS. 4, 5 and 7, the plurality of tine bars 206 are circumferentially spaced about the central rotating shaft. The plurality of tine bars 206 extend lengthwise across the harvester reel and are connected to the central rotating shaft 202 via mounting brackets 204. Each of the mounting brackets 204 extend radially from the central rotating shaft 202. The harvester reel 200 is illustrated with six tine bars, however the harvester reel can include more or fewer than six tine bars, such as one, two, three, four, five, seven, eight, nine, ten, or more. FIGS. 4, 5, 8, 9, 11 and 12 illustrate that each of the plurality of tine bars includes a follower or cam follower 254 operatively attached to an end of the tine bar and extending substantially transverse to the central longitudinal axis of the tine bar. According to an aspect, each follower 254 comprises an elongated shaft or bracket 256 and a curved head 258, but can alternatively be a slider, a bearing, a bushing and the like suitable for the stated intended purpose. As described in greater detail below, when the follower moves or rotates it rotates or moves the tine bar to which it is connected.

As best shown in FIGS. 6 and 7, an end of each of the plurality of tine bars 206 includes the biasing member 250. As illustrated, the biasing member 250 is positioned at an end or lateral end of the reel opposite the end of the reel which carries the follower 254, although it is understood that the biasing member may be positioned at the same end of the reel which carries the follower 254 or any other suitable position along the length of the reel. According to an exemplary embodiment, the biasing member 250 is a torsion spring having a first end 260 affixed to the tine bar and a second end 262 engaged with a bracket 264 affixed to the reel. The biasing member can alternatively be an elastomer, a leaf spring, a coil spring, a gas spring and the like. As more fully described below, when the follower 254 is in an uncammed state, the biasing member 250 biases the tine bar to extend substantially radially outwardly from the perimeter of the harvester reel. In other words, the biasing member biases the tine bar to position the tine to extend substantially transverse to a tangent of a circumference defined by rotation of the tine bar about the central rotating shaft 202. Conversely, when the follower 254 is in a fully cammed state, the bias of the biasing member is overcome whereby the tine bar extends substantially tangentially to the perimeter of the harvester reel, or in other words the longitudinal axis of the tine extends at an acute angle relative to a circumference defined by rotation of the tine bar about the central rotating shaft 202.

As shown in FIG. 2, the tines 252 are spaced apart along the length of each tine bar 206. According to exemplary embodiments, the tines can be fabricated from rigid material such as hard plastic or metal such as steel. The tines can range from about 3 to about 12 inches in length depending on the crop being harvested.

Referring again to FIG. 1, there is shown a primary cam 302 of a cam-type harvester reel, as well as structure for maintaining the primary cam stationary during rotation of the harvester reel 200. In particular, a bracket 320 is affixed to the cam 302 by unillustrated fasteners such as bolts, rivets, or the like. A distal portion of a reel lift arm 322 is secured to the bracket 320 and a proximal end of the reel lift arm is pivotably connected at 324 to the header frame 104. The connections of the primary cam to the bracket and the reel lift arm prevent rotation of the primary cam during rotation of the reel. The reel lift arm is raised and lowered by a reel lift arm actuator 309 such as a hydraulic cylinder or the like.

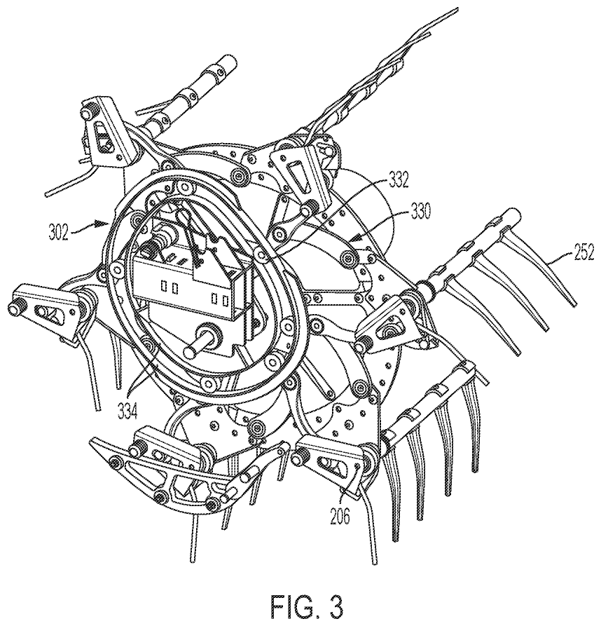

FIG. 3 shows a typical primary cam, such as primary cam 302. The non-circular shape of the primary cam dictates the degree to which the tine bars rotate during rotation of the central rotatable shaft 302, and thus the angle to which the tines 252 project from a circumference of the reel. In particular, each tine bar 206 has a respective linkage 330 that operatively links the tine bar with the primary cam 302. The linkage 330 includes a primary cam follower 332 that follows a cam track 334 of the primary cam as the reel rotates and moves the linkage with respect to the tine bar so as to rotate the tine bar about its longitudinal axis, thereby changing the angle the tines project from a circumference defined by rotation of the reel about the central rotatable shaft.

Referring to FIGS. 4 and 5, the harvester reel 200 is shown rotating in the direction of arrows “R”. The cam assembly 300 includes the primary cam 302 for guiding rotation of the tine bars 206 during rotation of the central rotatable shaft 202. In addition, the cam assembly 300 includes a secondary cam 304 moveable between a disengaged position (FIG. 4) and an engaged position (FIG. 5). The harvester reel 200 additionally comprises an actuator 306 for moving the secondary cam between the disengaged and engaged positions. The actuator 306 can be a pneumatic, hydraulic, servo, electromechanical, mechanical actuator and the like capable of moving at sufficient speed to deploy the secondary cam 304 to cam the tine bars 206 and thus the tines 252 out of contact with the cutterbar 110 as the cutterbar rises in relation to the harvester reel. The actuator is operatively in communication or configured to operatively communicate with a sensor 307 (FIG. 1) for detecting a position of the cutterbar 110 with respect to the harvester reel. In this way, the sensor communicates the position of the cutterbar with respect to the harvester reel. If the sensor detects that the cutterbar position is above a certain elevation or a predetermined elevation position, then the actuator is activated to move the secondary cam to the engaged position. In addition, the sensor 307 can be configured to communicate with the reel lift arm actuator 309 (FIG. 1) to raise the harvester reel relative to the cutterbar when the cutterbar reaches a certain elevation or a predetermined elevation position. Alternatively, the actuator, sensor and reel lift arm may be operatively in communication with a controller (e.g., a controller on the harvester or header) configured to control operation thereof based on predetermined parameters.

The secondary cam 304 is illustrated as being movable between first and second positions relative to the harvester reel. Specifically, the secondary cam is pivotably connected at pivot 308 to an unillustrated plate that is attached to the primary cam 302. It is understood, however, that the secondary cam can be supported to move in a linear fashion between the disengaged and engaged positions. The secondary cam 304 is positioned about a bottom region of the reel to facilitate camming of the tine bars such that they are retracted away from or otherwise disengaged from the cutterbar as the cutterbar comes into close proximity with the tines as further described below.

The secondary cam 304 includes a camming surface 310. FIG. 4 illustrates the secondary cam in the disengaged position whereby the camming surface 310 is out of contact with the curved heads 258 of tine bar followers 254. FIG. 4 also depicts nine positional instances (1-9) of a single tine bar follower approaching and passing the secondary cam 304. Under these circumstances, the tine bar follower 254 does not contact the camming surface 310 of the secondary cam 304 and the tine bar 206 is cammed or moved as dictated by the primary cam 302. As shown in FIG. 4, in the region of the secondary cam 304, the primary cam 302 cams the tine bar 206 such that the tine 252 extends substantially radially outwardly from the perimeter of the harvester reel.

FIG. 5 illustrates the secondary cam 304 in the engaged position wherein the actuator moves the secondary cam radially outwardly and the follower 254 of at least one of the plurality of reel tine bars 206 cams against the secondary cam. In other words, the secondary cam engages the follower of at least one of the plurality of reel tine bars pivoting the reel tine bar about its longitudinal axis. FIG. 5 also depicts nine positional instances (1′-9′) of a single tine bar follower approaching, contacting and engaging the secondary cam 304. Under these circumstances, the curved head 258 of the tine bar follower 254 contacts the camming surface 310 of the secondary cam 304 in positional instances 2′-7′ and the tine bar 206 is cammed as dictated by the shape of the camming surface 310 during that interval. As shown, the camming surface gradually cams the follower 254 from a position whereby the tine 252 extends substantially radially outwardly from the perimeter of the harvester reel (positional instance 2′) to a position whereby the tine extends substantially tangentially to the perimeter of the harvester reel (positional instance 6′) or at an acute angle relative to the perimeter of the harvester reel, to an uncammed position whereby the tine extends substantially radially outwardly from the perimeter of the harvester reel (positional instances 8′ and 9′). In other words, in the engaged position, the secondary cam 304 overcomes the bias of the of the biasing member 250 in positional instances 2′-7′ of the tine bar follower 254 and returns control to the biasing member at positional instances 8′ and 9′ of the tine bar follower, whereby the tine bar 206 and thus the tines 252 return to positions dictated by the shape of the primary cam 302. In the cammed positions, the overall length in which the tine extends radially outwardly from the reel is decreased thereby increasing the spacing distance of the tine from the cuter bar to prevent accidental engagement by the cutterbar.

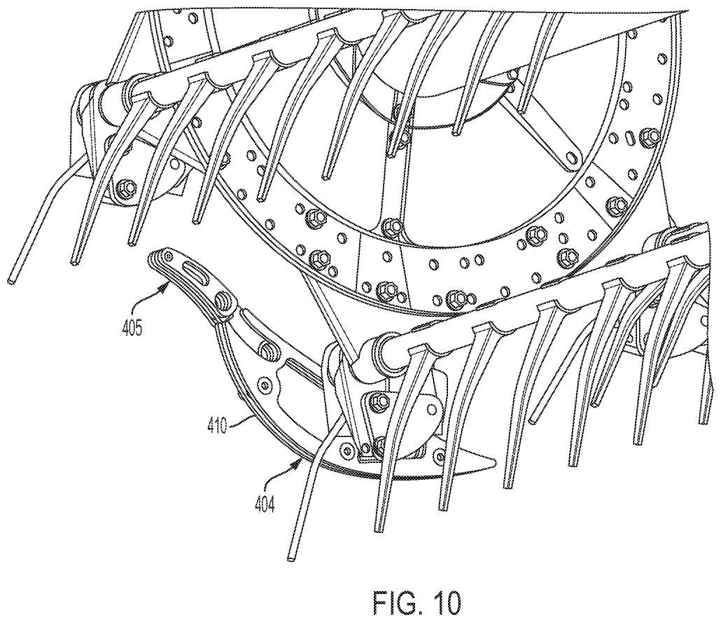

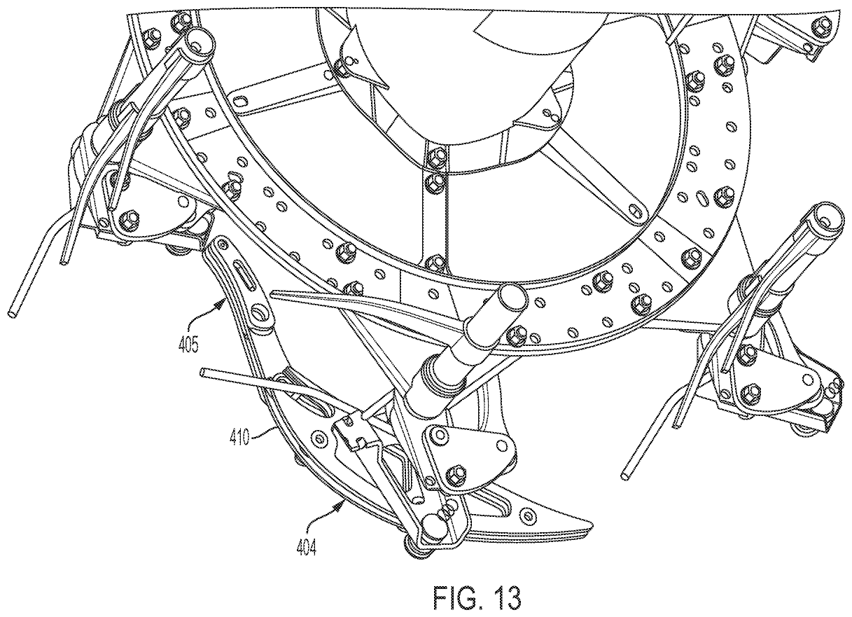

In accordance with another exemplary embodiment of the subject disclosure, FIGS. 8 and 11 illustrate a harvester reel 200′ rotating in the direction of arrows “R”, having a cam assembly 400. Cam assembly 400 includes a primary cam 402 similar to cam 302 for guiding rotation of the tine bars 206 during rotation of the central rotatable shaft 202. In addition, the cam assembly 400 includes a secondary cam 404 and a diverter 405 adjacent the secondary cam, wherein the diverter is moveable or pivotable between a disengaged position (FIGS. 8-10) and an engaged position (FIGS. 11-13). The secondary cam 404 and diverter 405 are positioned about a bottom region of the reel to facilitate camming of the tine bars such that they are disengaged or retracted as the cutterbar comes into close proximity with the tines as described below. The harvester reel 200′ additionally comprises an actuator 406 (FIGS. 8 and 11) for moving the diverter between the disengaged and engaged positions. The actuator 406 can be a pneumatic, hydraulic, servo, electromechanical, mechanical actuator and the like capable of moving at sufficient speed to deploy the diverter to cam the tine bars 206 and thus the tines 252 out of potential contact with the cutterbar 110 as the cutterbar rises in relation to the harvester reel. The actuator is configured for operatively communicating with or operatively in communication with the sensor 307 (FIG. 1) for detecting a position of the cutterbar 110 with respect to the harvester reel. In this way, the sensor detects and communicates with the controller or the harvester operator the position of the cutterbar with respect to the harvester reel. If the sensor detects the cutterbar position is above a certain elevation or a predetermined position, then the actuator is activated to move the diverter to the engaged position. In addition, the sensor 307 can be configured to communicate with the reel lift actuator 309 (FIG. 1) such as a hydraulic cylinder or the like to raise the harvester reel relative to the cutterbar when the cutterbar reaches a certain elevation or a predetermined position.

The secondary cam 404 includes a camming surface 410 facing radially outwardly of the reel. FIGS. 8-10 illustrate the diverter 405 pivoted downwardly by the actuator 406 into the disengaged or non-engaging position whereby the diverter and the camming surface 410 are out of contact with the curved heads 258 of tine bar followers 254. In other words, the diverter is structured such that the curved heads of the tine bar followers pass by the diverter without engaging the diverter when the diverter is pivoted downwardly into the disengaged position. Under these circumstances, the tine bar follower 254 does not contact the diverter or the camming surface of the secondary cam and the tine bar 206 is cammed or moved as dictated by the shape of the primary cam 402. As shown in FIG. 8, in the region of the secondary cam 404, the primary cam 402 cams the tine bars such that the tines 252 extends substantially radially outwardly from the perimeter of the harvester reel.

FIGS. 11-13 illustrate the diverter 405 pivoted or moved upwardly into the engaged position wherein the follower 254 of at least one of the plurality of reel tine bars 206 contacts and cams against the diverter and the secondary cam upon rotation of the central rotatable shaft. In other words, the actuator 406 is operable to move or pivot the diverter from the disengaged or non-engaging position shown in FIGS. 8-10 to the engaged or engaging position of FIGS. 11-13 whereby the diverter engages the follower of at least one of the plurality of tine bars pivoting the tine bar about its longitudinal axis. Under these circumstances, the curved head 258 of the tine bar follower 254 contacts the upwardly pivoted diverter 405 and the camming surface 410 of the secondary cam 404 whereby the tine bar 206 is cammed as dictated by the shapes of the diverter 405 and the camming surface 410. As shown, the diverter and the camming surface gradually cam the follower 254 from a position whereby the tine 252 extends substantially radially outwardly from the perimeter of the harvester reel to a position whereby the tine extends substantially tangentially to the perimeter of the harvester reel or at an acute angle to the perimeter of the harvester reel. In other words, in the engaged position of the diverter 405, the diverter and the secondary cam 404 overcome the bias of the biasing member 250 to rotate the tine bars and thus move the tines 252 away from the cutterbar 110 creating a larger spacing between the tines and the cutterbar, thereby reducing or completely eliminating the potential for cutterbar engagement with the tines. When the diverter is returned to the disengaged position, the tine bar 206 and thus the tines 252 return under the bias of the biasing member to positions dictated by the shape of the primary cam 402.

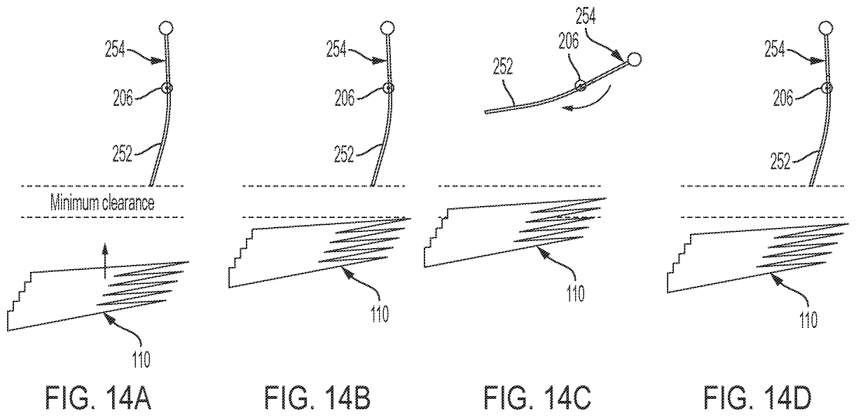

FIGS. 14A-14D illustrate sequential schematic views of the operation of a tine bar 206 in accordance with an exemplary embodiment of the subject disclosure as a cutterbar 110 approaches and moves away from a harvester reel.

Referring to FIG. 14A, the cutterbar 110 is shown rising in relation to an unillustrated harvester reel but has not yet reached a minimum clearance with respect to the harvester reel. In the state shown in FIG. 14A, the tine bar 206 extends as dictated by the shape of a primary cam of the harvester reel.

Referring to FIGS. 14B and 14C, the cutterbar 110 reaches a minimum clearance or a predetermined clearance position with respect to the harvester reel as determined by a sensor. As the cutter bar moves through the minimum clearance zone, the sensor communicates with an actuator to extend a secondary cam (FIGS. 4 and 5) or a diverter 405 (FIGS. 8-13) into contact with a follower 254 of the tine bar 206. At this juncture, the secondary cam rotates the tine bar against the bias of biasing member such that the tines 252 retract with respect to the cutterbar so as to avoid contact therewith.

Referring to FIG. 14D, as the cutterbar 110 moves downwardly out of the minimum clearance zone, the sensor communicates with an actuator to retract the secondary cam or the diverter out of contact with the follower 254 of the tine bar 206. At this juncture, the biasing member biases the tine bar to rotate such that the tines 252 return to an engaged position dictated by the primary cam.

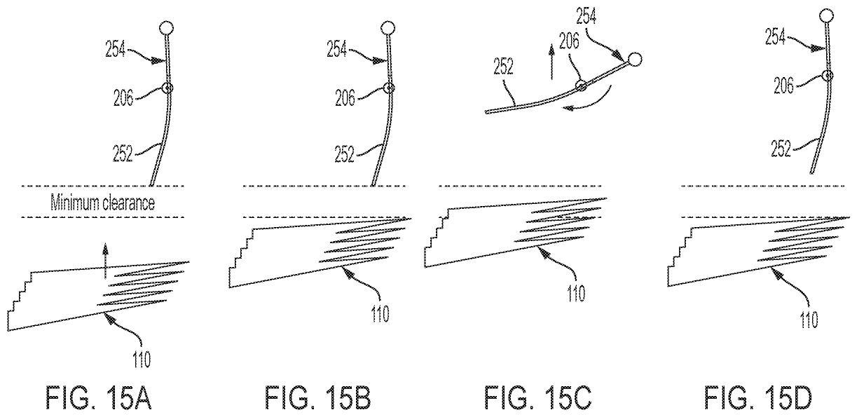

FIGS. 15A-15D illustrate sequential schematic views of the operation of a tine bar 206 in accordance with another exemplary embodiment of the subject disclosure as a cutterbar 110 approaches and moves away from a harvester reel.

Referring to FIG. 15A, the cutterbar 110 is shown rising in relation to an unillustrated harvester reel but has not yet reached a minimum clearance with respect to the harvester reel. In the state shown in FIG. 15A, the tine bar 206 extends as dictated by the shape of a primary cam of the harvester reel.

Referring to FIGS. 15B and 15C, the cutterbar 110 reaches a minimum clearance or a predetermined clearance position with respect to the harvester reel as determined by a sensor. As the cutter bar moves through the minimum clearance zone, the sensor communicates with an actuator to extend a secondary cam (FIGS. 4 and 5) or a diverter 405 (FIGS. 8-13) into contact with a follower 254 of the tine bar 206. At this juncture, the secondary cam rotates the tine bar against the bias of biasing member such that the tines 252 retract with respect to the cutterbar so as to avoid contact therewith. Concurrently, the sensor communicates with a reel lift actuator (FIG. 1) to raise the harvester reel relative to the cutterbar.

Referring to FIG. 15D, the reel itself may be raised thereby raising the minimum clearance zone itself if the cutterbar remains elevated due to e.g., an engaged expanse of raised ground. In that event, the reel remains raised until the sensor and/or controller determines it is safe to extend the tines. Once the sensor and/or controller determines it is safe to extend the tines, e.g., as the cutterbar 110 can be moved downwardly out of the minimum clearance zone, the sensor communicates with an actuator to retract the secondary cam or the diverter out of contact with the follower 254 of the tine bar 206. At this juncture, the biasing member biases the tine bar to rotate such that the tines 252 return to an engaged position dictated by the primary cam.

It will be appreciated by those skilled in the art that changes could be made to the exemplary embodiments described above without departing from the broad inventive concept thereof. It is to be understood, therefore, that the subject disclosure is not limited to any particular exemplary embodiments disclosed, but it is intended to cover modifications within the spirit and scope of the subject disclosure as defined by the appended claims.

What is claimed is:

1. A harvester reel for an agricultural harvester header comprising:
a central rotatable shaft;
a plurality of reel tine bars extending widthwise across the reel and connected to the central rotatable shaft for rotation therewith, each of the plurality of reel tine bars including:
a biasing member biasing each reel tine bar to rotate about a central longitudinal axis of each reel tine bar, and
a tine; and
a cam assembly for guiding rotation of the plurality of reel tine bars.

2. The harvester reel of claim 1, wherein each of the plurality of reel tine bars further comprises a cam follower for engaging the cam assembly.

3. The harvester reel of claim 2, wherein the cam follower comprises an elongated shaft and a curved head.

4. The harvester reel of claim 1, wherein the cam assembly comprises:
a primary cam for guiding rotation of the tine bars during rotation of the central rotatable shaft; and
a secondary cam moveable between a disengaged position and an engaged position.

5. The harvester reel of claim 4, wherein each of the plurality of reel tine bars further comprises a cam follower extending from the reel tine bar, and wherein in the engaged position, the cam follower of at least one of the plurality of reel tine bars cams against the secondary cam.

6. The harvester reel of claim 4, wherein each of the plurality of reel tine bars further comprises a follower extending from the reel tine bar, and wherein in the engaged position, the secondary cam engages the follower of at least one of the plurality of reel tine bars pivoting the reel tine bar about its longitudinal axis.

7. The harvester reel of claim 4, wherein the cam assembly further comprises an actuator for moving the secondary cam between the disengaged and engaged positions.

8. The harvester reel of claim 7, further comprising a sensor for detecting a position of a cutterbar with respect to the harvester reel, and wherein the sensor is operatively in communication with the actuator.

9. The harvester reel of claim 1, wherein the cam assembly comprises:
a primary cam for guiding rotation of the tine bars during rotation of the central rotatable shaft;
a secondary cam; and
a diverter adjacent the secondary cam, wherein the diverter is movable between a disengaged position and an engaged position.

10. The harvester reel of claim 9, wherein in the engaged position, a follower of at least one of the plurality of reel tine bars cams against the diverter and the secondary cam upon rotation of the central rotatable shaft.

11. The harvester reel of claim 9, wherein each of the plurality of reel tine bars further comprises a follower, and wherein in the engaged position, the diverter engages the follower of at least one of the plurality of reel tine bars pivoting the reel tine bar about its longitudinal axis.

12. The harvester reel of claim 9, wherein the cam assembly further comprises an actuator for moving the diverter between the disengaged and engaged positions.

13. The harvester reel of claim 12, further comprising a sensor for detecting a position of a cutterbar with respect to the harvester reel, and wherein the sensor is operatively in communication with the actuator.

14. An agricultural harvester header comprising:
the harvester reel of claim 1; and
a cutterbar carried below the harvester reel.

15. An agricultural harvester comprising the agricultural harvester header of claim 14.

16. A harvester reel for an agricultural harvester header comprising:
a central rotatable shaft; and
a plurality of reel tine bars extending widthwise across the reel and connected to the central rotatable shaft for rotation therewith, each of the plurality of reel tine bars including:
a biasing member for biasing the reel tine bar to rotate about its central longitudinal axis,
a follower operatively connected to the reel tine bar, and
a tine; and
a cam assembly that includes:
a primary cam for guiding rotation of the tine bars during rotation of the central rotatable shaft,
a secondary cam,
a diverter adjacent the secondary cam, wherein the diverter is movable between a disengaged position and an engaged position, wherein in the engaged position, the follower of at least one of the plurality of reel tine bars cams against the secondary cam, and
an actuator for moving the diverter between the disengaged and engaged positions.

17. A harvester reel for an agricultural harvester header comprising:
a central rotatable shaft;
a plurality of reel tine bars extending widthwise across the reel and connected to the central rotatable shaft for rotation therewith; and
a cam assembly for guiding rotation of the plurality of reel tine bars, the cam assembly including:
a primary cam for guiding rotation of the tine bars during rotation of the central rotatable shaft, and
a secondary cam moveable between a disengaged position and an engaged position.

18. The harvester reel of claim 17, wherein each of the plurality of reel tine bars comprises a cam follower, and wherein in the engaged position, the cam follower of at least one of the plurality of reel tine bars cams against the secondary cam.

19. The harvester reel of claim 17, wherein each of the plurality of reel tine bars comprises a cam follower, and wherein in the engaged position, the secondary cam engages the cam follower of at least one of the plurality of reel tine bars moving the reel tine bar between first and second positions.

20. A harvester reel for an agricultural harvester header comprising:
a central rotatable shaft;
a plurality of reel tine bars extending widthwise across the reel and connected to the central rotatable shaft for rotation therewith; and
a cam assembly for guiding rotation of the plurality of reel tine bars, the cam assembly including:
a primary cam for guiding rotation of the tine bars during rotation of the central rotatable shaft,
a secondary cam, and
a diverter adjacent the secondary cam, wherein the diverter is movable between a disengaged position and an engaged position.

21. The harvester reel of claim 20, wherein in the engaged position, a cam follower of at least one of the plurality of reel tine bars cams against the diverter and the secondary cam upon rotation of the central rotatable shaft.

22. The harvester reel of claim 20, wherein each of the plurality of reel tine bars further comprises a cam follower, and wherein in the engaged position, the diverter engages the follower of at least one of the plurality of reel tine bars pivoting the reel tine bar about its longitudinal axis.

23. A harvester reel for an agricultural harvester header comprising:
a central rotatable shaft;
a plurality of rotatable reel tine bars extending widthwise across the reel and connected to the central rotatable shaft for rotation therewith;
a primary tine bar guiding mechanism configured to guide rotation of the tine bars during rotation of the central rotatable shaft; and
a secondary tine bar guiding mechanism configured to guide rotation of the tine bars during a portion of a complete revolution of rotation of the central rotatable shaft.

24. The harvester reel of claim 23, wherein the primary tine bar guiding mechanism comprises a primary cam for guiding rotation of the tine bars during rotation of the central rotatable shaft.

25. The harvester reel of claim 23, wherein the secondary tine bar guiding mechanism comprises a secondary cam moveable between a disengaged position and an engaged position.

26. The harvester reel of claim 23, wherein the secondary tine bar guiding mechanism comprises:
a secondary cam, and
a diverter adjacent the secondary cam, wherein the diverter is movable between a disengaged position and an engaged position.
